(19) United States
(12) Patent Application Publication
(10) Pub. No.: US 2008/0254209 A1
(43) Pub. Date: Oct. 16, 2008

(54) POLYMER ICE AND METHODS OF MAKING AND USING THE SAME

(75) Inventor: John R. Dorgan, Golden, CO (US)

Correspondence Address: BERENBAUM, WEINSHIENK & EASON, P.C, 370 17TH STREET, SUITE 4800, DENVER, CO, 80202, US

(73) Assignee: POLYNEW, INC., Golden, CO (US)

(21) Appl. No.: 12/099,037

(22) Filed: Apr. 7, 2008

Related U.S. Application Data
(60) Provisional application No. 60/910,613, filed on Apr. 6, 2007.

(51) Int. Cl. C10M 169/00; B05D 5/00

(52) U.S. Cl. 427/136; 508/304; 427/412; 427/407.1

(57) ABSTRACT

The development provides polymer compositions that may restrict mobility of moving people, animals and objects within an area, including individual combatants and vehicles. The polymer-based compositions create an artificial ice material to directedly and reversibly reduce ground traction. The development also may include a non-toxic reversal agent, matched to the chemical characteristics of the polymer compositions, that restores traction when applied to a surface coated with the initial, traction-reducing polymer.

### CROSS-REFERENCE TO RELATED APPLICATIONS

The present application claims priority from the U.S. Provisional Application No. 60/910,613, filed 6 Apr. 2007, entitled “POLYMER ICE AND METHODS OF MAKING AND USING THE SAME”; the subject matter of which hereby being specifically incorporated herein by reference for all that it discloses and teaches.

### BACKGROUND

The development relates to chemical means of traction reduction and restoration of baseline levels of coefficient of friction. The anti-traction material may be used to deny mobility of personnel and vehicles to selected areas. Additionally, the persistence time of the anti-traction coating may be controllable through variation of the exact formulation.

The unrestricted mobility of enemy forces in the crowded urban battlespace, including individual combatants and vehicles, severely reduces the effectiveness of military and peacekeeping operations. This, coupled with difficulties in the identification of adversaries amongst the local populace, creates a dangerous, uncertain, high-risk environment that risks coalition and civilian casualties. As such, there is an immediate need for methods to deny enemy transit while simultaneously maintaining transit for friendly and allied forces.

The razor blade industry has long sought ways to lubricate the razor-to-face interface, the first proposed solid lubricant in the form of a solid surface was invented by Booth (Booth A R. 1979. U.S. Pat. No. 4,170,821) Microencapsulated silicone oil in a polyethylene matrix was proposed. Later, an open-celled foam impregnated with a lubricating composition of unsaturated fatty acids was proposed (Etheredge R W. 1988. U.S. Pat. No. 4,872,263) and methods for mounting lubricating strips were improved (Ferraro F A. 1987. U.S. Pat. No. 4,697,342, Jacobson C F. 1984. U.S. Pat. No. 4,587,729, Simms G J, Oldroyd B. 1993. U.S. Pat. No. 5,224,267) Specialized polymer blends have been developed for razor lubricating strips; the earliest included about half thermoplastic (polyethylene), about 40% high molecular weight poly(ethylene oxide), and the remainder being polylactone (Ramachandran R, Dinunzi S A. 1996. U.S. Pat. No. 5,589,545) In the mid-1990s, the Gillette company recognized the importance of controlling morphology and introduced blends of a water insoluble thermoplastic matrix, a water soluble polymer, and a compatibilizing polymer (Yin Y, Tseng M M. 1994. U.S. Pat. No. 5,454,164). Other patented formulations include polyacrylamide as the water soluble component and polyurethane as the insoluble component (Chadwick B W, Wang A, Bradanini K. 1999. U.S. Pat. No. 5,956,849). The number of patents in lubricating shaving razors has grown to be very large, however, this brief review of the technical literature demonstrates that as a result of a lot of effort at corporations, much is known about making polymer blends that are as slippery as possible when contacted with water. The high lubricity of these materials is possible at very low surface coverage (a strip of approximately 1 mm in thickness, 3 mm in width, and 35 mm in length weighs about 100 mg—this lasts for at least 6 months of daily shaving (surface area about 300 cm2 per face) or covers 5.4 m2 corresponding to only 18.5 milligrams dry polymer per m2. Allowing a 100 fold increase in the polymer concentration (to 1.85 grams per m2) still provides 8 grams of lower molecular weight liquid carrier per square meter.

The use of polymer slurries and gels has been previously disclosed as a means of denying traction to adversaries. Mallow discloses a polymer slurry consisting of an emulsion or dispersion of polymer in water emulsified by a hydrocarbon and including an anionic acrylamide polymer particle (U.S. Pat. No. 7,067,464, Jun. 27, 2006). Also, Scribner discloses a system for dispersing anti-traction materials (U.S. Pat. No. 7,186,443, Mar. 6, 2007).

### SUMMARY

The present development provides an effective solution based on the basic tenet that to get from Point A to Point B, one must have sufficient traction with the ground. The present development provides the use of a polymer-based artificial ice material to effectively control mobility by the precise and reversible reduction of ground traction. The polymer based compositions of the present development replicate the properties of black ice, i.e., a thin, translucent, slippery coating of ice on solid surfaces that forms spontaneously in cold temperatures. But, the polymer compositions of the present development may be used in a broad range of hot, arid environments, such as those found in Iraq and Afghanistan. A further component of the present development is non-toxic reversal agents, matched to the chemical characteristics of the polymer compositions, which restore traction when applied to a surface coated with one of the polymer compositions. Incorporation of the reversal agent into footwear and/or tires, to achieve substantially instantaneous traction restoration on contact, provides asymmetric mobility capabilities to that may prove highly beneficial to warfighters and police officers. This substantially instantaneous traction restoration is akin to having the ability to run effortlessly on wet ice, while adversary mobility is simultaneously severely restricted.

### BRIEF DESCRIPTION

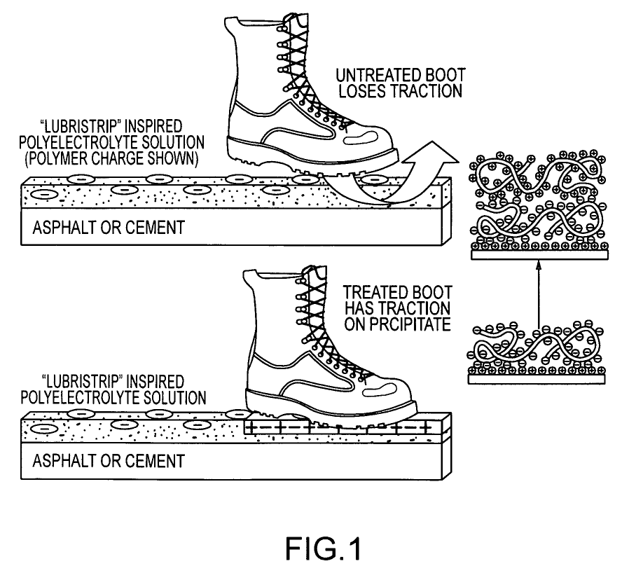

FIG. 1 shows a schematic of the surface and the collapse of the lubricious layer as a result of salting out resulting from application and reversal of the traction modifying polymer compositions of the present development.

### DETAILED DESCRIPTION

The present development is drawn to methods of modifying traction characteristics that can provide a selective advantage of mobility for mammals and/or equipment on a solid surface. An easily applicable and camouflage capable polymer ice has been developed. Such material may consist of a non-soluble thermoplastic matrix with a dispersed high molecular weight water-soluble polymer that releases from the matrix upon wetting; these highly optimized formulations provide a dramatically reduced coefficient of friction at extremely low surface concentrations. Particularly, this coating may have as constituents poly(ethylene oxide), water, alcohol and a polyelectrolyte. The poly(ethylene oxide) may be molecularly branched.

The alcohol may be a methanol, an ethanol, a propanol, a butanol, a pentanol, a higher carbon chain alcohol including multifunctional alcohols such as glycerol or polyols, or combinations thereof.

The polyelectrolyte may be poly(2-acrylamido-2-methyl-1-propanesulfonic acid), poly(acrylamido-N-propyltrimethylammonium chloride), poly(styrene sulfonate), poly(styrene nitrate), poly(acrylic acid) (PAA), polyethyleneimine (PEI), Poly(vinyl amine), a protein, a polysaccharide, quaternary cationic polyelectrolytes (ammonium, sulfonium, and phosphonium), poly((dimethylamino)ethylmethacrylate) (PAMA), poly(allylamine hydrochloride) (PAH), poly(diallyl dimethyl-ammonium chloride) (PDADMAC), poly(L-glutamic acid) (PGA), poly(L-lysine) (PLL), poly(methacrylic acid) (PMA), poly(vinyl pyridine) (PVP), structural derivatives of the foregoing, or combinations thereof. The polyelectrolyte may be molecularly branched.

The salt may be ammonium (NH₄⁺), calcium (Ca²⁺) iron (Fe²⁺ and Fe³⁺) magnesium (Mg²⁺) potassium (K⁺), pyridinium (C₅H₅NH⁺), quaternary ammonium (NR₄⁺), sodium (Na⁺) with the following anions: acetate CH₃COO, carbonate CO₃², chloride Cl⁻, citrate HOC(COO⁻)(CH₂COO⁻)₂, cyanide (C≡N⁻), hydroxide (OH⁻), nitrate (NO₃⁻), nitrite (NO²⁻), oxide (O²⁻), phosphate (PO₄³⁻), sulfate (SO₄²⁻) or combinations thereof.

The lubricious coating may also contain a biodegradable polymer such as starch, a form of cellulose or other polysacharides, poly(lactic acid), polyhydroxyalkanoates, polyhydroxybutyrates, poly(glutamic acid), proteins, lignin, natural rubber, copolymers or combinations thereof.

This non-toxic and inexpensive technology may be dispensed in the form of pumps, hoses, artillery shells, hand grenades or the like to disperse the high molecular weight water-soluble polymer with variable specificity to a specified area. The duration of the reduced coefficient of friction effect may be tuned through inclusion of glycols, higher alcohols, and polyols in place of water to reduce evaporation and maintain effectiveness for extended and selectable time periods.

Reversibility may be engineered into the system by using a strongly acidic, water soluble polyelectrolyte, such as poly(2-acrylamido-2-methyl-1-propanesulfonic acid) or PolyAMPS, in the polymer layer and a counteracting, strongly basic polyelectrolyte of opposite charge, such as poly(acrylamido-N propyltrimethylammonium chloride) or PolyAPTAC, as an applicable counter-agent. Upon contact, the two polyelectrolytes salt out giving a precipitate that provides local traction; the rapid molecular dynamics of these strongly charged systems provides a near instantaneous response. In one related embodiment, a biologically based and biodegradable thermoplastic (polylactide or PLA) is included to enhance the material clean-up while minimizing any long term environmental impacts.

The principle exploited to aid reversibility is the well-known salting out of polyelectrolytes of opposite charge. When polyelectrolytes of opposite charge come into contact, they rapidly precipitate, timescales can be in the millisecond range. Accordingly the lubricity provided by the dissolved water soluble polymer is lost and the surface regains a greater coefficient of friction. This effect is shown schematically in FIG. 1.

In FIG. 1, the polyelectrolyte solution 10 carries a negative charge 12. The polyelectrolyte solution 10 is dispersed on, for example, asphalt or cement 14. An untreated boot 16 of a wearer (not shown) crossing the asphalt or cement 14 coated with the polyelectrolyte solution 10 will lose traction, as shown by arrow 18.

As further illustrated in FIG. 1, a treated boot 20 would carry, i.e., a positive charge 22. The wearer (also not shown) of the treated boot 20 would be afforded traction 24, as illustrated by the ‘neutralized’ strip 24.

The polymer formulations disclosed here have many desirable features. They may be inexpensive, allowing widespread deployment. They may be applied using simple equipment or may be deployed by spray or through the use of an explosive or chemically propelled device, such as a hand grenade or artillery shell, to spread the polymer formulations in an area. They may be formulated using biodegradable, eco-friendly polymers that are non-toxic. They may be pigmented to match the existing surface of interest, providing camouflage that would not reveal their presence. The needed mass is generally very low and the formulations may be designed to have tunable traction.

In one embodiment, the polymer compositions may be formulated to be placed in areas of need but not activated until needed.

In an alternative embodiment, the polymer compositions may be formulated to be active upon application and to remain active for specified periods of time.

The behavior of polyelectrolytes is a complex topic within macromolecular chemistry and physics. Various comprehensive reviews of polyelectrolyte (PE) behavior are available. These polymers are affected by the pH of the solution, the solution ionic strength, and presence of an oppositely-charged surface. The idea of using a precipitating polyelectrolyte pair has been proposed as a basic building block for self-assembling nanostructures (Ulrich S, Seijo M, Stoll S. 2006. The many facets of polyelectrolytes and oppositely charged macroions complex formation. Current Opinion in Colloid & Interface Science 11: 268-72). The binding can be induced by a long range (electrostatic) attractive interaction referred to as polyelectrolyte bridging (Podgornik R, Li\check{c}er M. 2006. Polyelectrolyte bridging interactions between charged macromolecules. Current Opinion in Colloid & Interface Science 11: 273-9). Different morphologies are possible depending upon the nature of the two polyelectrolytes interacting, and it is possible to mediate the interactions, for example, by forming a polyelectrolyte multilayer structure or having a mixture that is already partially complexed (Sukhishvili S A, Kharlampieva E, Izumrudov V. 2006. Where Polyelectrolyte Multilayers and Polyelectrolyte Complexes Meet. Macromolecules 39). That is, the electrostatic interactions may be tuned, compositional variation of the ratio of oppositely charged polyelectrolytes can be used as a means of controlling the demixing. Various thermodynamic instabilities can occur leading to demixing on rapid time scales, often of milliseconds (Bhuiyan L B, Vlachy V, Outhwaite C W. 2002. Understanding polyelectrolyte solutions: macroion condensation with emphasis on the presence of neutral co-solutes. International Reviews in Physical Chemistry 21: 1-36). Thus, the ability to engineer very slippery polymer mixtures and the known ability of PEs to rapidly precipitate provide reversible systems.

In certain embodiments of the present development, the poly-electrolyte polymer compositions are non-fouling systems. That is, the oppositely charged counteragent on boots and tires generally would not simply pick-up multiple layers of counter-charged polymer. Once the boot is completely neutralized it would be incapable of inducing precipitation and providing traction. One route to overcoming fouling is simple reapplication of the counteragent. But this periodic reapplication may be cumbersome and ineffective. Clearly, a counteragent is desirable that lasts as long as possible. Therefore, one embodiment of the present development is the introduction of as many charge sites on the counteragent as possible using a highly branched, dendritic or arborescent polyelectrolyte. In a related embodiment of the present development, the chemistry of adhesion of both polyelectrolyte layers provides adhesion to each underlying surface (i.e. both the floor and the boot or tire, respectively).

The traction-effecting compositions may contain poly(ethylene oxide), water, glycerin, ethylene glycol, other higher alcohols, polyAMPS, poly(lactic acid) and combinations thereof, depending upon the intended use and desired activation, dispersal and reversal characteristics.

In some embodiments, the disclosed compositions are passive and do not actively attack the underlying surface. Additionally, clean-up may be possible using an ionic solution engineered to precipitate and flocculate the polymer components. Therefore, one embodiment of the present development is a cleaning solution that shares many mechanistic features with the counter-agent. Additionally, the thermoplastic used in these embodiments may be biodegradable poly(lactic acid), thermoplastic starch, polyhydroxybutyrates or their mixtures.

Additional objects, advantages, and novel features of this development will become apparent to those skilled in the art upon examination of the following examples thereof, which are not intended to be limiting.

The foregoing description of the present development has been presented for purposes of illustration and description. Furthermore, the description is not intended to limit the development to the form disclosed herein. Consequently, variations and modifications commensurate with the above teachings, and the skill or knowledge of the relevant art, are within the scope of the present development. The embodiment described hereinabove is further intended to explain the best mode known for practicing the development and to enable others skilled in the art to utilize the development in such, or other, embodiments and with various modifications required by the particular applications or uses of the present development. It is intended that the appended claims be construed to include alternative embodiments to the extent permitted by the prior art.

What is claimed is:

1. A lubricious coating comprising poly(ethylene oxide), water, alcohol, polyelectrolyte and a salt.

2. The lubricious coating according to claim 1 in which the poly(ethylene oxide) is molecularly branched.

3. The lubricious coating according to claim 1 wherein the alcohol is one or more of a methanol, an ethanol, a propanol, a butanol, a pentanol, a higher carbon chain alcohol including multifunctional alcohols such as glycerol or polyols, or combinations thereof.

4. The lubricious coating according to claim 1 wherein the polyelectrolyte is one or more of poly(2-acrylamido-2-methyl-1-propane sulfonic acid), poly(acrylamido-N-propyltrimethylammonium chloride), poly(styrene sulfonate), poly(styrene nitrate), poly(acrylic acid) (PAA), polyethyleneimine (PEI), Poly(vinyl amine), a protein, a polysaccharide, quaternary cationic polyelectrolytes (ammonium, sulfonium, and phosphonium), poly((dimethylamino)ethylmethacrylate) (PAMA), poly(allylamine hydrochloride) (PAH), poly(diallyl dimethyl-ammonium chloride) (PDADMAC), poly(L-glutamic acid) (PGA), poly(L-lysine) (PLL), poly(methacrylic acid) (PMA), poly(vinyl pyridine) (PVP), a structural derivative of the foregoing, or combinations thereof.

5. The lubricious coating of claim 4 in which the polyelectrolyte is molecularly branched.

6. The lubricious coating according to claim 1, wherein the salt is one or more of ammonium (NH₄⁺), calcium (Ca²⁺) iron (Fe²⁺ and Fe³⁺) magnesium (Mg²⁺) potassium (K⁺), pyridinium (C₅H₅NH⁺), quaternary ammonium (NR₄⁺), sodium (Na⁺) with the following anions: acetate CH₃COO⁻, carbonate CO₃², chloride Cl⁻, citrate HOC(COO⁻)(CH₂COO⁻)₂, cyanide (C≡N⁻), hydroxide (OH, nitrate (NO₃⁻), nitrite (NO²⁻), oxide (O²⁻), phosphate (PO₄³⁻), sulfate (SO₄²⁻) or combinations thereof.

7. The lubricious coating according to claim 1, further comprising a biodegradable polymer selected from the group consisting of starch, a form of cellulose or other polysacharides, poly(lactic acid), polyhydroxyalkanoates, polyhydroxybutyrates, poly(glutamic acid), proteins, lignin, natural rubber, copolymers and combinations thereof.

8. The lubricious coating of claim 1, wherein the lubricious coating is one or more of inexpensive, easily applied, non-toxic, biodegradable, and functional in very low volumes.

9. A method of modifying the traction characteristics of a solid surface comprising applying a first lubricious coating according to claim 1 to a solid surface.

10. The method of claim 9, wherein the first lubricious coating contains a polyelectrolyte having a certain charge.

11. A method of modifying the traction characteristics of a solid surface comprising applying a first lubricious coating according to claim 1 to a solid surface, further comprising the step of restoring the traction characteristics of the solid surface by applying a second lubricious coating according to claim 1.

12. The method of claim 11, wherein the polyelectrolyte in the second lubricious coating has a charge opposite to the charge of the polyelectrolyte in the first lubricious coating.

13. The method of claim 11, further comprising the step of restoring the traction characteristics of the solid surface by applying a salt mixture.

14. The method of claim 9, wherein the solid surface is one or more of piece of human footwear, a vehicle tire, a roadway, or structural flooring.

15. The method of claim 9, further comprising disposing the lubricious coating within an explosive or chemically propelled device capable of dispersing the lubricious coating upon arrival at a target area.

16. The method of claim 13, wherein the explosive or chemically propelled device is an artillery shell or a hand grenade.
